(19) United States
(12) Patent Application Publication
(10) Pub. No.: US 2007/0217532 A1
(43) Pub. Date: Sep. 20, 2007

(54) Apparatus and method for acquiring frame synchronization in broadband wireless communication system

(75) Inventors: Sung-Woo Park, Suwon-si (KR); Ki-Young Han, Yongin-si (KR); Soon-Young Yoon, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/714,012

(22) Filed: Mar. 5, 2007

(30) Foreign Application Priority Data
Mar. 3, 2006 (KR) 2006-0020322

(51) Int. Cl. H04K 1/10; H04L 27/06

(52) U.S. Cl. 375/260; 375/343

(57) ABSTRACT

Provided are an apparatus and a method for acquiring frame synchronization in a broadband wireless communication system using a plurality of preamble sub-carrier patterns. The apparatus includes a plurality of preamble detectors that perform phase compensation on input sample data in accordance with a corresponding pattern and computes correlation values for respective time indices by using the phase-compensated sample data; an adder that sums the correlation values received from the preamble detectors; and a synchronization determination unit that compares sums obtained from the adder so as to select a maximum value and determines a time index corresponding to the maximum value as the frame synchronization.

### PRIORITY

This application claims priority under 35 U.S.C. § 119 to an application filed in the Korean Intellectual Property Office on Mar. 3, 2006 and assigned Serial No. 2006-20322, the contents of which are hereby incorporated by reference.

### BACKGROUND OF THE INVENTION

1. Field of the Invention

The present invention relates to an apparatus and method for acquiring frame synchronization in a broadband wireless communication system, and more particularly, to an apparatus and method for improving the capability of frame synchronization acquisition in a cell overlap region.

2. Description of the Related Art

A wireless communication technique has recently witnessed rapid development as its methods change from analog to digital. A system based on an Orthogonal Frequency Division Multiplexing (OFDM) is taken into account for a transmission scheme applicable to various post-3rd generation (3G) mobile communication systems. This is because high speed communication with low equalization complexity is possible at a frequency-selective fading channel.

In a cellular system environment, communication between a mobile station and a base station is carried out in such a manner that a start point of a frame transmitted from the base station is first identified after power is turned on and then information on a cell and a sector to which the mobile station currently belongs is obtained. For this process, a sufficient number of base station identifiers are required. Further, the mobile station has to be able to determine a base station identifier of a corresponding base station with low complexity and high possibility of detection.

In general, for each frame section, the base station transmits a preamble symbol having a specific pattern. Various methods may be used to design the preamble pattern. At present, in one of the most popular methods, a unique Pseudo Random (PN) sequence of the base station is delivered over a sub-carrier with a specific time interval in a frequency domain. Similar to this method, sequence mapping may be carried out with the specific time interval instead of delivering the sequence over all of the sub-carriers. In this case, regarding a signal of a time domain, a specific pattern is repeated within an OFDM symbol after an Inverse Fast Fourier Transform (IFFT) operation is performed. The number of repetitions varies depending on a sequence mapping interval.

FIGS. 1A and 1B illustrate a preamble characteristic in a conventional broadband wireless communication system.

An example of sequence allocation in a frequency domain is shown in FIG. 1A. Pattern repetition in a time domain is shown in FIG. 1B.

Referring to FIGS. 1A and 1B, one sequence is allocated with an interval of four sub-carriers in the frequency domain, and as a result; the same pattern is repeated four times within an OFDM symbol. By utilizing such a repetition characteristic of the preamble OFDM symbol, frame synchronization (or a start point) can be easily acquired. After the frame synchronization is acquired, the preamble symbol undergoes a Fast Fourier Transform (FFT) operation to obtain a unique PN sequence of a base station so that cell search is carried out. In order to reduce the number of PN sequences required in this process, the preamble sub-carrier may be allocated using several allocation patterns.

The aforementioned preamble configuration has been or is expected to be adopted in post-3G mobile communication system standards such as the Institute of Electrical and Electronic Engineers (IEEE) 802.16e, IEEE 802.20, and 3G Partnership Project (3GPP) Long Term Evolution (LTE).

Conventionally, when the frame synchronization is acquired by using the repetition characteristic in the time domain, an auto-correlation scheme (or a delayed correlation scheme) has been widely used. In the case of a mobile station with low implementation complexity, the auto-correlation scheme is commonly used since it is relatively simple and there is no need to know a transmission preamble pattern.

As described with reference to FIGS. 1A and 1B, if an FFT size is N_{fft}, and one PN sequence sample is mapped with an interval of Nᵣₑₚ sub-carriers in the frequency domain, then data which has undergone an IFFT operation has a structure in which N_{fft}/Nᵣₑₚ time-sampled data are repeated Nᵣₑₚ times. By using this feature, a frame start point \hat{n} is determined by Equation (1).

$$\hat{n} = \begin{matrix}arg max \\ n\end{matrix} \vert {\sum }_{k = 0}^{{N}_{corr} - 1} y * ( n - k - ⌊ {N}_{fft} / {N}_{rep} ⌋ ) y ( n - k ) \vert \qquad ( 1 )$$

Here, y(k) denotes a signal received at a time index k, and N_{corr} denotes a correlation size. For example, the correlation size may be defined as N_{fft}+N_{cp}−floor(N_{fff}/Nᵣₑₚ) or N_{fft}-floor(N_{fft}/Nᵣₑₚ), where a Cyclic Prefix (CP) length of an OFDM symbol is N_{cp}. Accumulation values are computed while increasing a start index n of an accumulation time point. The maximum value of the computed accumulation values is determined as the frame start point \hat{n}.

However, a problem arises in the aforementioned frame start point determination method when several patterns are used to map the PN sequence to the sub-carrier. This is because synchronization acquisition may not be successfully achieved due to Inter-Cell Interference (ICI) existing in a cell overlap region. The following description will be made for the case where, besides the PN sequence, three types of preamble patterns (referred to as segments 0, 1, and 2) are used to distinguish a cell and a sector.

FIG. 2 illustrates a sub-carrier mapping method in the conventional broadband wireless communication system using three preamble patterns.

Referring to FIG. 2, in the segment 0, PN sequences are mapped to sub-carrier indices 0, 3, and 6. In the segment 1, PN sequences are mapped to sub-carrier indices 1, 4, and 7. In the segment 2, PN sequences are mapped to sub-carrier indices 2, 5, and 8. According to this method, when a total of N_{ID} identifiers are required to distinguish a base station and a sector, N_{ID}/3 PN sequences may be used to distinguish the base station and the sector.

In the case of using three sectors with one segment being allocated to each of the sectors, an auto-correlation value at a frame start point for each sector is defined by Equation (2).

$$\begin{matrix}Segment 0 \text{:} & {C}_{o} = {\sum }_{k = 0}^{{N}_{corr} - 1} {\vert y ( k ) \vert}^{2} \\ Segment 1 \text{:} & {C}_{1} = {\sum }_{k = 0}^{{N}_{corr} - 1} {\vert y ( k ) \vert}^{2} exp ( j2 π / 3 ) = {\sum }_{k = 0}^{{N}_{corr} - 1} {\vert y ( k ) \vert}^{2} w \\ Segment 2 \text{:} & {C}_{2} = {\sum }_{k = 0}^{{N}_{corr} - 1} {\vert y ( k ) \vert}^{2} exp ( j4 π / 3 ) = {\sum }_{k = 0}^{{N}_{corr} - 1} {\vert y ( k ) \vert}^{2} {w}^{- 1}\end{matrix} \qquad ( 2 )$$

In the segment 0 of Equation (2), a preamble sequence is symmetrically mapped with respect to a center of a Direct Current (DC) tone (or a sub-carrier).

If a mobile station receives only one signal, that is, if there is no interference, the frame synchronization can be acquired by using a magnitude of an auto-correlation value irrespective of phase change.

If the mobile station concurrently receives preambles of different segments from two base stations in the cell overlap region, the auto-correlation value at the frame start point is expressed by Equation (3). Here, phase delay and noise between a transmitter and a receiver are not taken into account.

$${C}_{0 , 1} = {\sum }_{k = 0}^{{N}_{corr} - 1} \{ {\vert {y}_{0} ( k ) \vert}^{2} + {\vert {y}_{1} ( k ) \vert}^{2} w \} + {\sum }_{k = 0}^{{N}_{corr} - 1} \{ {y}_{1}^{*} ( k ) {y}_{0} ( k ) + {y}_{0}^{*} ( k ) {y}_{1} ( k ) w \} \qquad ( 3 )$$

Here, yᵢ(k) denotes a signal received from a base station using a preamble of a segment i. Due to low correlation between y₀(k) and y₁(k), the second term of the equation has a small value if several sample data are used to obtain a correlation value. Thus, the second term does not significantly affect synchronization capability. Hence, it is the first term that affects the synchronization capability. Although the first term has a small value according to a phase component of w, the frame synchronization can be acquired without any problem.

The phase component of w may lead to deterioration in capability in a place where more cells are expected to overlap with one another. FIG. 3 illustrates an input signal in a frequency domain when preambles of different segments are simultaneously received in a three-cell overlap region. Referring to FIG. 3, the preamble signals of the different segments are received as interference signals.

In this case, an auto-correlation value at a preamble start point is expressed by Equation (4).

$${C}_{0 , 1 , 2} = {\sum }_{k = 0}^{{N}_{corr} - 1} \{ {\vert {y}_{0} ( k ) \vert}^{2} + {\vert {y}_{1} ( k ) \vert}^{2} w + {\vert {y}_{2} ( k ) \vert}^{2} {w}^{- 1} \} + {\sum }_{k = 0}^{{N}_{corr} - 1} \{ \begin{matrix}{y}_{ 1}^{*} ( k ) {y}_{ 0} ( k ) + {y}_{ 0}^{*} ( k ) {y}_{ 1} ( k ) w + {y}_{ 0}^{*} ( k ) {y}_{ 2} ( k ) {w}^{- 1} + \\ {y}_{ 2}^{*} ( k ) {y}_{ 0} ( k ) w + {y}_{ 1}^{*} ( k ) {y}_{ 2} ( k ) {w}^{- 1} + {y}_{ 2}^{*} ( k ) {y}_{ 1} ( k ) w\end{matrix} \} \qquad ( 4 )$$

Here, the second term may be ignored due to non-correlation of a preamble transmitted from each base station. If

$${\sum }_{k = 0}^{{N}_{corr} - 1} {\vert {y}_{0} ( k ) \vert}^{2} = {\sum }_{k = 0}^{{N}_{corr} - 1} {\vert {y}_{1} ( k ) \vert}^{2} = {\sum }_{k = 0}^{{N}_{corr} - 1} {\vert {y}_{2} ( k ) \vert}^{2} ,$$

that is, if the mobile station receives similar signal power from each base station, the first term becomes 0.

In other words, the conventional method of acquiring frame synchronization has a disadvantage in that synchronization acquisition cannot be achieved if preamble signals with different patterns of the same magnitude are received from three base stations in the three-cell overlap region.

### SUMMARY OF THE INVENTION

In order to solve the above problems and/or disadvantages and to provide the advantages below, the present invention provides an apparatus and method for improving capability of frame synchronous acquisition in an Orthogonal Frequency Division Multiplexing (OFDM)-based cellular communication system.

The present invention also provides an apparatus and method for improving capability of frame synchronous acquisition in a cell overlap region in an OFDM-based cellular communication system.

The present invention also provides an apparatus and method for acquiring frame synchronization by obtaining a correlation value of an input signal for each pattern in a broadband wireless communication system using a plurality of preamble sub-carrier patterns.

According to one aspect of the present invention, there is provided an apparatus for acquiring frame synchronization in a broadband wireless communication system using a plurality of preamble sub-carrier patterns, the apparatus including a plurality of preamble detectors for performing phase compensation on input sample data in accordance with a corresponding pattern and computes correlation values for respective time indices by using the phase-compensated sample data; an adder for summing the correlation values received from the preamble detectors; and a synchronization determination unit for comparing sums obtained from the adder so as to select a maximum value and determining a time index corresponding to the maximum value as the frame synchronization.

According to another aspect of the present invention, there is provided an apparatus for acquiring frame synchronization in a broadband wireless communication system using a plurality of preamble sub-carrier patterns, the apparatus including a determination unit for comparing correlation values for the patterns obtained from a preamble detector, identifying a pattern having a maximum correlation value, and providing the maximum correlation value to the preamble detector; the preamble detector for performing phase compensation on input sample data in accordance with a corresponding pattern by the use of information received from the determination unit and computing the correlation values for respective time indices by using the phase-compensated sample data; and a synchronization determination unit for comparing the correlation values obtained from the preamble detector to select a maximum correlation value and determining a time index corresponding to the maximum correlation value as the frame synchronization.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B illustrate a preamble characteristic in the conventional broadband wireless communication system;

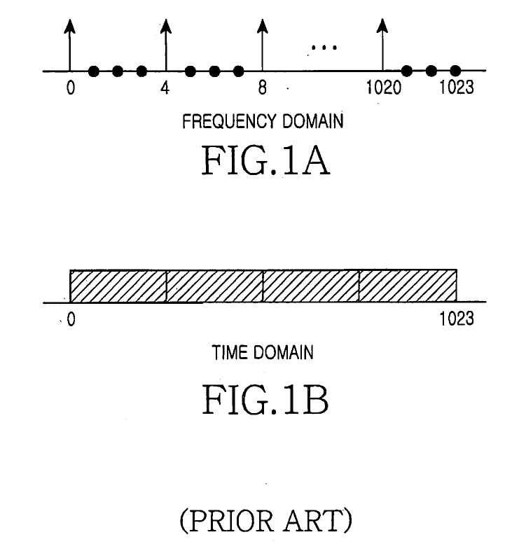

FIG. 2 illustrates a sub-carrier mapping method in the conventional broadband wireless communication system using three preamble patterns;

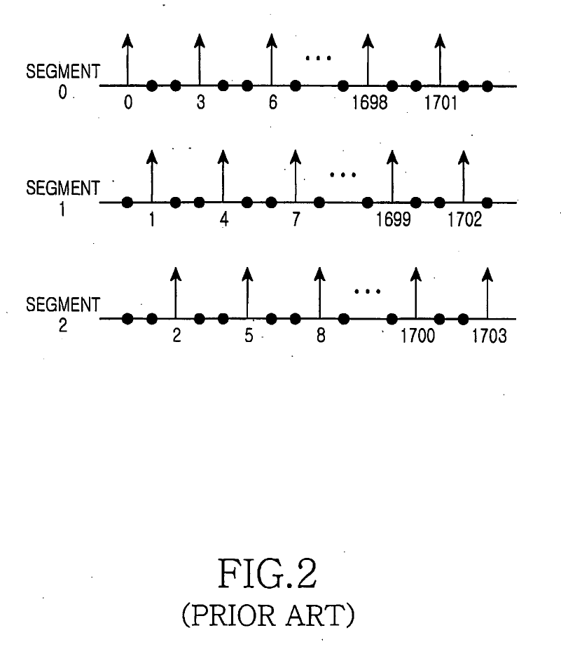

FIG. 3 illustrates an input signal in a frequency domain when preambles of different segments are simultaneously received in a three-cell overlap region;

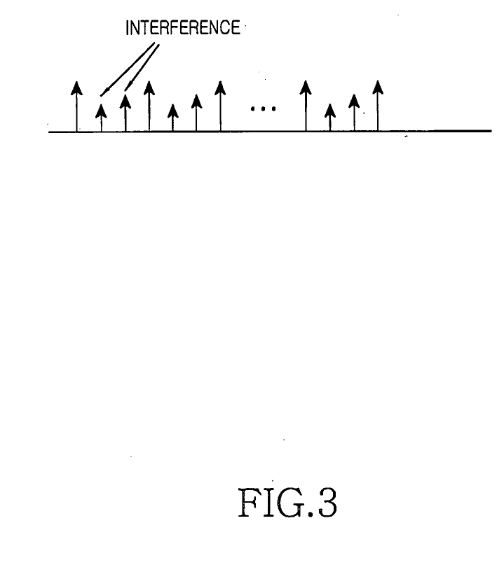

FIG. 4 is a block diagram of an apparatus for acquiring frame synchronization in a broadband wireless communication system according to the present invention;

FIG. 5 is a flowchart illustrating a procedure of frame synchronization acquisition in a broadband wireless communication system according to the present invention;

FIG. 6 is a block diagram of an apparatus for acquiring frame synchronization in a broadband wireless communication system according to the present invention;

FIG. 7 is a block diagram of an apparatus for acquiring frame synchronization in a broadband wireless communication system using multiple antennas according to the present invention; and

FIG. 8 is a detailed block diagram of a preamble detector according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail. Terminology used herein should be determined in consideration of functionality of the present invention, and it may be variable depending on user's or operator's intention, or customs in the art. Therefore, corresponding meaning should be determined with reference to the entire specification.

A method of improving frame synchronization acquisition capability will now be described in a broadband wireless communication system using a plurality of preamble sub-carrier patterns.

In the present invention, in order to improve the frame synchronization acquisition capability, a correlation value of an input signal is computed for each preamble sub-carrier pattern. Then, a frame start point is determined by using the computed correlation value. The correlation value is obtained in such a manner that a total of Nᵣₑₚ repeated sample data are summed and accumulated for a correlation time period. Before a sum of the repeated sample data is computed, a phase compensation operation is carried out for a pattern. If a total number of preamble sub-carrier patterns is Nᵣₑₚ, a correlation value for a pattern index i at a time index n is computed by Equation (5).

$${C}_{i} ( n ) = {\sum }_{k = 0}^{{N}_{corr} - 1} {\vert {\sum }_{m = 0}^{{N}_{rep} - 1} y ( n - k - m \cdot ⌊ \frac{{N}_{fft}}{{N}_{rep}} ⌋ ) exp ( - \frac{j 2 π m ⅈ}{{N}_{rep}} ) \vert}^{2} \qquad ( 5 )$$

A correlation time period N_{corr} may be determined to be └N_{fft}/Nᵣₑₚ┘+N_{CP}.

Acquisition of synchronization using the correlation value Cᵢ(n)(i=0, 1, . . . ,Nᵣₑₚ−1) for each obtained pattern may have a parallel structure or a serial structure. The parallel structure will be first described.

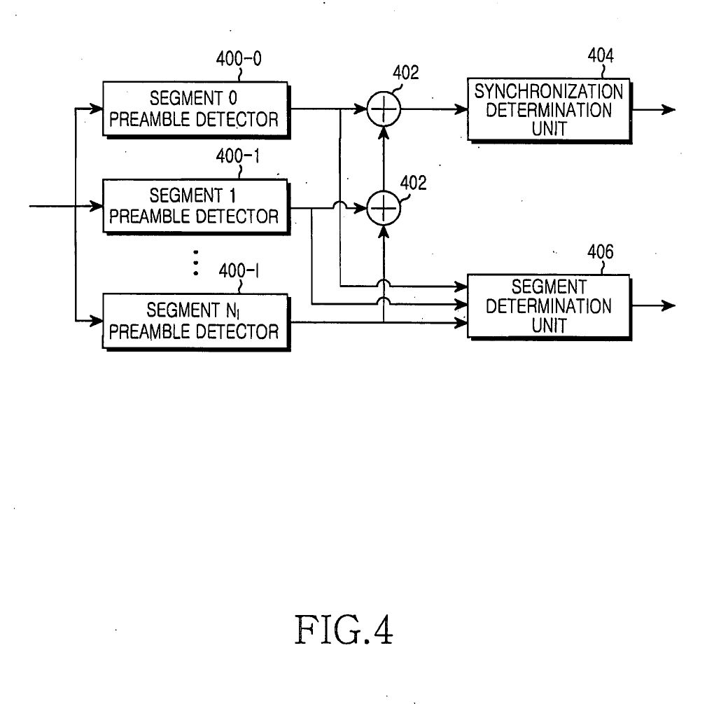

FIG. 4 is a block diagram of an apparatus for acquiring frame synchronization in a broadband wireless communication system according to the present invention.

Referring to FIG. 4, the apparatus includes preamble detectors 400-0 to 400-I, in the number of which is equal to the number of patterns (or segments), adders 402, a synchronization determination unit 404, and a segment determination unit 406. Data input to the preamble detectors 400-0 to 400-I is sample data of a time domain. Here, Each segment has a corresponding adder.

The 0^{th} preamble detector 400-0 correlates the input sample data according to Equation (5) so as to obtain a correlation value C₀(n) for the 0^{th} pattern. In this case, since a segment index 0 is substituted for the index i, phase compensation is not achieved for the sample data. The 0^{th} preamble detector 400-0 computes sums of the Nᵣₑₚ repeated sample data and accumulates the sums for the correlation time period, thereby obtaining a correlation value of the 0^{th} pattern.

The first preamble detector 400-1 correlates the input sample data according to Equation 5 so as to obtain a correlation value Cᵢ(n) for the first pattern. In this case, since a segment index 1 is substituted for the index i, phase compensation is achieved for the sample data. The first preamble detector 400-1 performs the phase compensation on the Nᵣₑₚ repeated sample data before computing sums thereof and then accumulates the sums for the correlation time period, thereby obtaining a correlation value of the first pattern.

Likewise, the rest of preamble detectors 400-2 to 400-I also correlate each input sample data according to Equation (5) so as to obtain correlation values of respective patterns. The operations of the preamble detectors 400-0 to 400-I are performed in a parallel manner as illustrated.

The adder 402 sums the correlation values C₀(n) to C₁(n) output from the preamble detectors 400-0 to 400-I with respect to each time index.

The synchronization determination unit 404 compares the sums obtained from the adder 402 to select a maximum value. A time index n corresponding to the maximum value is determined as the frame synchronization. In this case, the operations of the adder 404 and the synchronization determination unit 402 are expressed by Equation (6).

$$\tilde{n} = \begin{matrix}arg max \\ n\end{matrix} {\sum }_{i = 0}^{{N}_{rep} - 1} {C}_{i} ( n ) \qquad ( 6 )$$

The segment determination unit 406 compares correlation values obtained from the preamble detectors 400-0 to 400-I and then identifies a segment having the greatest correlation value. The identified segment may be used later for cell identification.

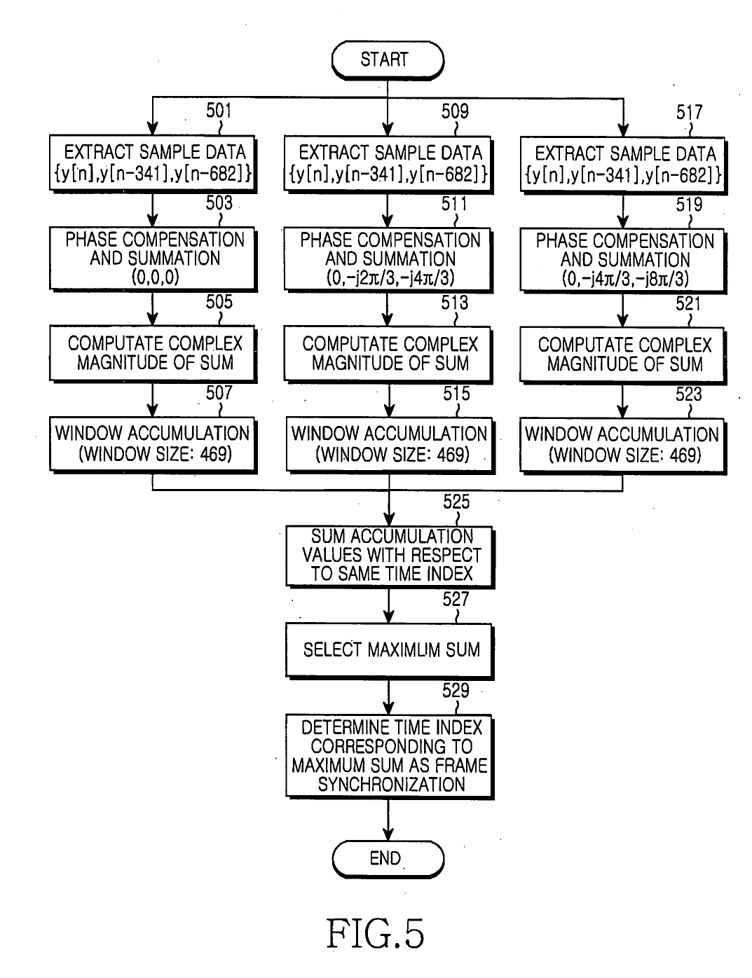

FIG. 5 is a flowchart illustrating a procedure of frame synchronization acquisition in a broadband wireless communication system according to the present invention. Referring to FIG. 5, steps 501 to 507, steps 509 to 515, and steps 517 and 523 are simultaneously performed. It will be assumed, for purposes of an example, that an FFT size is 1024, and three preamble sub-carrier patterns (or segments) are used.

In step 501, a mobile station first extracts three repeated sample data y(n), y(n-341), and y(n-682) from the input sample data according to a time index n. Here, n is 0, 1, 2, . . .

In step 503, the three repeated sample data undergo phase compensation and are summed to obtain a sum thereof. Since steps 501 to 507 indicate operations for obtaining a correlation value of the 0^{th} segment, the phase compensation in step 503 is not carried out in practice. After the three repeated sample data are summed, in step 505 the mobile station calculates the complex magnitude of the sum. In other words, the magnitude is calculated by squaring the absolute value of the sum.

In step 507, the calculated magnitudes are accumulated in a sliding widow manner so as to obtain an accumulation value. For example, the window size may be 496 (samples per unit time).

The operations of steps 509 to 515 and the operations of steps 517 to 523 are also performed in the same manner as described above, and thus detailed descriptions thereof will be omitted. However, there is a difference in that phase compensation is carried out for corresponding segments in steps 511 and 519.

After a correlation value is obtained for each segment, in step 525 the mobile station sums the obtained correlation values for each time index. Then, in step 527, the mobile station compares sums obtained from the summation so as to select a maximum value. In step 529, the mobile station determines a time index n corresponding to the maximum value as the frame synchronization.

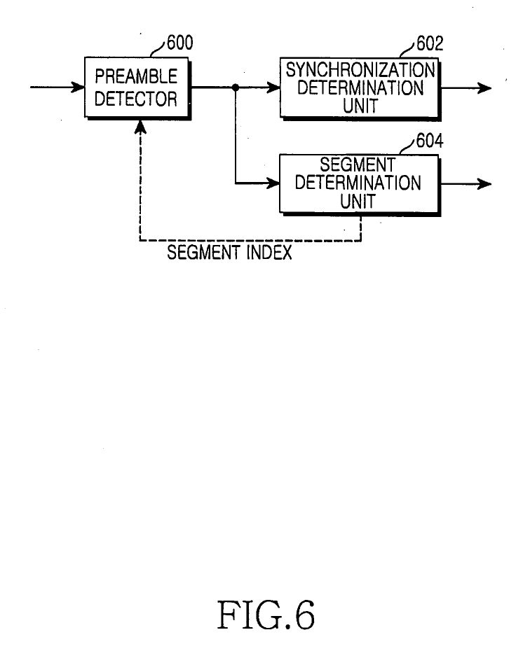

FIG. 6 is a block diagram of an apparatus for acquiring frame synchronization in a broadband wireless communication system according to the present invention.

Referring FIG. 6, the apparatus includes a preamble detector 600, a synchronization determination unit 602, and a segment determination unit 604. Data input to the preamble detector 600 is sample data in a time domain.

The preamble detector 600 obtains a correlation value Cᵢ(n) for each pattern according to Equation (5). The correlation values output from the preamble detector 600 are provided to the synchronization determination unit 602 and the segment determination unit 604.

The segment determination unit 604 compares the correlation values input from the preamble detector 600 so as to identify a segment having a maximum value. The segment determination unit 604 controls the preamble detector 600 so that the correlation values can be obtained for the identified segment. The identified segment may be used later for cell identification.

Under the control of the segment determination unit 604, the preamble detector 600 computes the correlation values only for the identified segment according to Equation (5). The synchronization determination unit 602 compares the correlation values obtained from the preamble detector 600 so as to select a maximum value and then determines a time index n corresponding to the maximum value as the frame synchronization. The operation of the synchronization determination unit 602 is expressed as Equation (7).

$$\tilde{n} = \begin{matrix}arg max \\ n\end{matrix} {C}_{i} ( n ) \qquad ( 7 )$$

A serial structure of FIG. 6 has slightly inferior capability to the aforementioned parallel structure. Nonetheless, there is merit in that hardware complexity can be reduced since only one preamble detector is required. In addition thereto, a hybrid structure may be used in which the serial structure and the parallel structure are properly combined.

The present invention may be applied to a Multiple Input Multiple Output (MIMO) method which has been recently popularized.

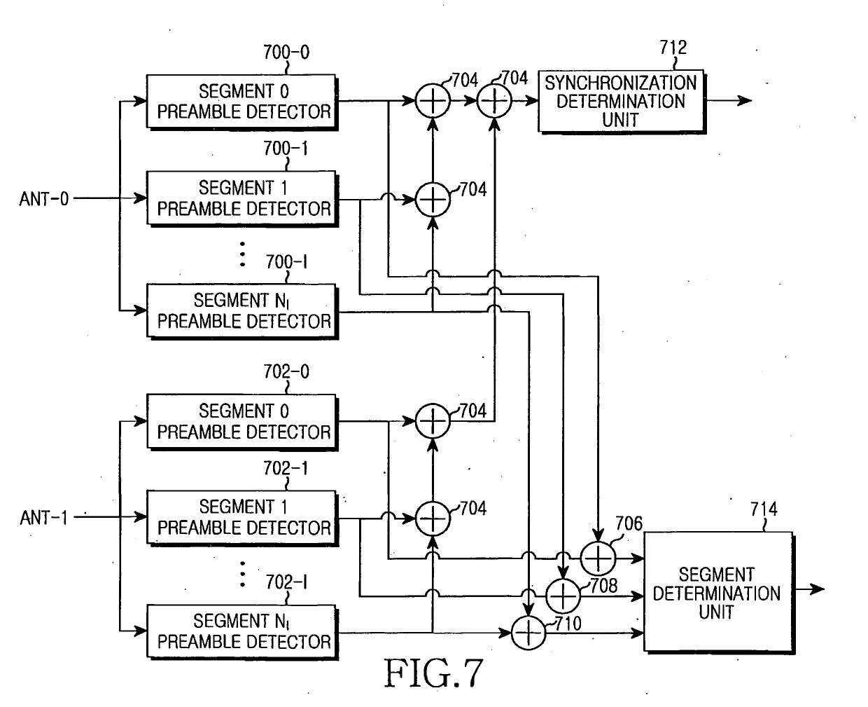

FIG. 7 is a block diagram of an apparatus for acquiring frame synchronization in a broadband wireless communication system using multiple antennas according to the present invention. Hereinafter, for example purposes, it will be assumed that two reception antennas are used.

Referring to FIG. 7, the apparatus includes a plurality of preamble detectors 700-0 to 700-1 and 702-0 to 702-I, a plurality of adders 704, 706, 708, and 710, a synchronization determination unit 712, and a segment determination unit 714.

Each of the preamble detectors 700-0 to 700-I corresponding to the 0^{th} antenna ANT-0 correlates sample data received through the 0^{th} antenna ANT-0 according to Equation (5) and computes a correlation value of a corresponding pattern. In other words, each of the preamble detectors 700-0 to 700-I performs phase compensation for the Nᵣₑₚ repeated sample data and then obtains a sum thereof. The magnitudes of the sums (complex signal-magnitudes) are accumulated for a specific correlation time period to obtain the correlation value of the corresponding pattern.

Each of the preamble detectors 702-0 to 702-I corresponding to the first antenna ANT-1 correlates sample data received through the first antenna ANT-1 according to Equation (5) and computes a correlation value of a corresponding pattern. In other words, each of the preamble detectors 702-0 to 702-I performs phase compensation for the Nᵣₑₚ repeated sample data and then obtains a sum thereof. The magnitudes of the sums are accumulated for a specific correlation time period to obtain the correlation value of the corresponding pattern.

The adder 704 sums the correlation values output from the preamble detectors 700-0 to 700-I and 702-0 to 702-I for the 0^{th} and first antennas ANT-0 and ANT-1 with respect to each time index and provides the summation result to the synchronization determination unit 712. Thereafter, the synchronization determination unit 712 compares sums obtained from the adder 704 and selects a maximum value. Then, synchronization determination unit 712 determines a time index n corresponding to the maximum value as the frame synchronization.

The adder 706 sums the correlation value obtained from the 0^{th} preamble detector 700-0 of the 0^{th} antenna and the correlation value obtained from the 0^{th} preamble detector 702-0 of the first antenna and then provides the summation result to the segment determination unit 714. The adder 708 sums the correlation value obtained from the first preamble detector 700-1 of the 0^{th} antenna and the correlation value obtained from the first preamble detector 702-1 of the first antenna and then provides the summation result to the segment determination unit 714. Likewise, the adder 710 sums the correlation value obtained from the i-th preamble detector 700-I of the 0^{th} antenna and the correlation value obtained from the i-th preamble detector 702-I of the first antenna and then provides the summation result to the segment determination unit 714.

The segment determination unit 714 compares the correlation values output from the adders 706 to 710. Then, the segment determination unit 714 identifies a segment having a maximum value. The identified segment may be used later for cell identification.

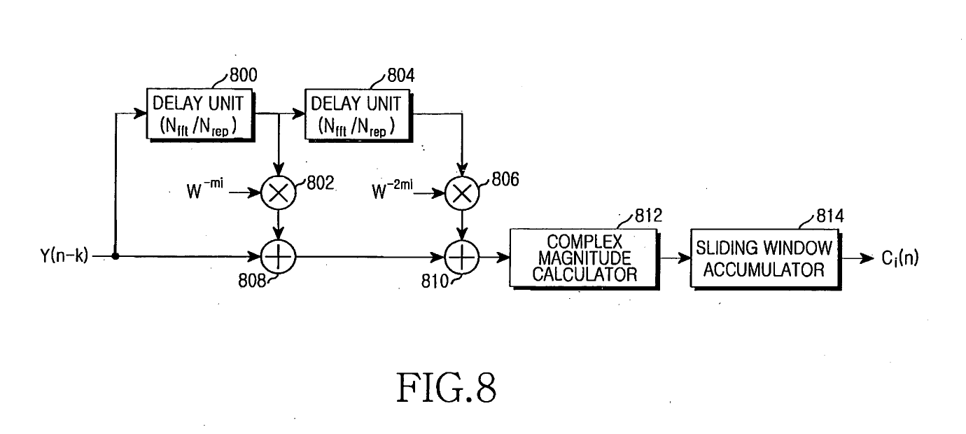

FIG. 8 is a detailed block diagram of a preamble detector shown in FIGS. 4, 6, and 7. In particular, FIG. 8 is shown assuming that three preamble sub-carrier patterns (or segments) are used.

Referring to FIG. 8, the preamble detector includes delay units 800 and 804, multipliers 802 and 806, adders 808 and 810, a complex magnitude calculator 812, and a sliding window accumulator 814.

The first delay unit 800 delays the input sample data with a time delay of N_{fft}/Nᵣₑₚ. The first multiplier 802 compensates the phase of the sample data received from the first delay unit 800. The second delay unit 804 delays the sample data received from the first delay unit 800 with the time delay of N_{fft}/Nᵣₑₚ. The second multiplier 806 compensates the phase of the sample data received from the second delay unit 804.

The first adder 808 sums the input sample data and the sample data received from the first multiplier 802. The second adder 810 sums the sample data received from the first adder 808 and the sample data received from the second multiplier 806 in response to a corresponding sampling interval.

The complex magnitude calculator 812 calculates a complex magnitude of a sum obtained from the second adder 810 by squaring its absolute value. The sliding window accumulator 814 accumulates the magnitudes obtained from the complex magnitude calculator 812 in a sliding window manner, thereby obtaining a correlation value Cᵢ(n) for the i-th pattern.

According to the present invention, an initial synchronization failure can be solved in a cell overlap region of a broadband wireless communication system. The present invention has an advantage in that initial synchronization capability can be improved in all OFDM systems in which a preamble is repeated in a time domain and a plurality of preamble sub-carrier patterns are present in a frequency domain.

While the invention has been shown and described with reference to certain preferred embodiments thereof, it will be understood by those skilled in the art that various changes in form and details may be made therein without departing from the spirit and scope of the invention as defined by the appended claims. For example, another method may be used in which a snapshot of input sample data is taken, correlation values for respective preamble sub-carrier pattern are sequentially computed in an off-line manner using one preamble detector, correlation values for a plurality of patterns are summed up for respective time indices so that frame synchronization is searched for. Therefore, the scope of the invention is defined not by the detailed description of the invention but by the appended claims, and all differences within the scope will be construed as being included in the present invention.

What is claimed is:

1. An apparatus for acquiring frame synchronization in a broadband wireless communication system using a plurality of preamble sub-carrier patterns, the apparatus comprising:
a plurality of preamble detectors for phase compensating input sample data in accordance with a corresponding pattern and computing correlation values for respective time indices by using the phase-compensated sample data;
an adder for summing the correlation values received from the preamble detectors; and
a synchronization determination unit for comparing sums obtained from the adder so as to select a maximum value and determining a time index corresponding to the maximum value as the frame synchronization.

2. The apparatus of claim 1, wherein the preamble detectors each comprise:
an adder for phase compensating the input sample data in accordance with the corresponding pattern and summing the phase-compensated sample data with a specific time interval;
a magnitude calculator for computing the magnitudes of the sums obtained from the adder; and
a sliding window accumulator for accumulating the magnitudes obtained from the magnitude calculator in a sliding window manner so as to generate the correlation values for respective time indices.

3. The apparatus of claim 1, wherein the preamble detector corresponding to an i-th pattern computes a correlation value Cᵢ(n) for a time index n according to
$${C}_{i} ( n ) = {\sum }_{k = 0}^{{N}_{corr} - 1} {\vert {\sum }_{m = 0}^{{N}_{rep} - 1} y ( n - k - m \cdot ⌊ \frac{{N}_{fft}}{{N}_{rep}} ⌋ ) exp ( - \frac{j 2 π m ⅈ}{{N}_{rep}} ) \vert}^{2} ,$$
where i denotes an index of a preamble sub-carrier pattern, y( ) denotes input sample data, N_{fft} denotes a fast Fourier transform (FFT) size, and Nᵣₑₚ denotes the number of repetitions of a preamble in a time domain.

4. The apparatus of claim 1, further comprising a determination unit for comparing the correlation values received from the preamble detectors and identifying a pattern having a maximum correlation value.

5. An apparatus for acquiring frame synchronization in a broadband wireless communication system using a plurality of preamble sub-carrier patterns, the apparatus comprising:
a determination unit for comparing correlation values for the patterns obtained from a preamble detector, identifying a pattern having a maximum correlation value, and providing the maximum correlation value to the preamble detector;
the preamble detector for performing phase compensation on input sample data in accordance with a corresponding pattern by the use of information received from the determination unit and computing the correlation values for respective time indices by using the phase-compensated sample data; and
a synchronization determination unit for comparing the correlation values obtained from the preamble detector to select a maximum correlation value and determining a time index corresponding to the maximum correlation value as the frame synchronization.

6. The apparatus of claim 5, wherein the preamble detector comprises:
an adder for phase compensating the input sample data in accordance with a corresponding pattern and summing the phase-compensated sample with a specific time interval;
a magnitude calculator for computing the magnitudes of the sums obtained from the adder; and
a sliding window accumulator for accumulating the magnitudes obtained from the magnitude calculator in a sliding window manner so as to generate the correlation values for respective time indices.

7. The apparatus of claim 5, wherein the preamble detector computes a correlation value for a time index n according to
$${C}_{i} ( n ) = {\sum }_{k = 0}^{{N}_{corr} - 1} {\vert {\sum }_{m = 0}^{{N}_{rep} - 1} y ( n - k - m \cdot ⌊ \frac{{N}_{fft}}{{N}_{rep}} ⌋ ) exp ( - \frac{j 2 π m ⅈ}{{N}_{rep}} ) \vert}^{2} ,$$
where i denotes an index of a preamble sub-carrier pattern, y( ) denotes input sample data, N_{fft} denotes a fast Fourier transform (FFT) size, and Nᵣₑₚ denotes the number of repetitions of a preamble in a time domain.

8. A method of acquiring frame synchronization in a broadband wireless communication system using a plurality of preamble sub-carrier patterns, the method comprising the steps of:
computing, with respect to each of the preamble sub-carrier patterns, correlation values for respective time indices by using input sample data after performing phase compensation on the input sample data in accordance with a corresponding pattern;
summing the correlation values of the patterns with respect to each time index; and
comparing sums obtained from the summation so as to select a maximum value and determining a time index corresponding to the maximum value as the frame synchronization.

9. The method of claim 8, wherein the computation step comprises:
performing phase compensation on the input sample data in accordance with the corresponding pattern and summing the phase-compensated sample data with a specific time interval;
computing the complex magnitudes of the sums; and
computing a correlation value of a corresponding pattern with respect to each time index by accumulating the magnitudes in a sliding window manner.

10. The method of claim 8, wherein a correlation value for a time index n is obtained according to
$${C}_{i} ( n ) = {\sum }_{k = 0}^{{N}_{corr} - 1} {\vert {\sum }_{m = 0}^{{N}_{rep} - 1} y ( n - k - m \cdot ⌊ \frac{{N}_{fft}}{{N}_{rep}} ⌋ ) exp ( - \frac{j2π m i}{{N}_{rep}} ) \vert}^{2} ,$$
where i denotes an index of a preamble sub-carrier pattern, y( ) denotes input sample data, N_{fft} denotes a fast Fourier transform (FFT) size, and Nᵣₑₚ denotes the number of repetitions of a preamble in a time domain.

11. The method of claim 8, further comprising comparing the correlation values of the patterns and identifying a pattern having a maximum correlation value.

12. A method of acquiring frame synchronization in a broadband wireless communication system using a plurality of preamble sub-carrier patterns, the method comprising the steps of:
identifying a pattern having a maximum correlation value by comparing correlation values of the respective patterns after computing the correlation values of the respective patterns;
computing the correlation values for respective time indices by using input sample data after performing phase compensation on the input sample data with respect to the identified pattern; and
comparing the computed correlation values so as to select a maximum value and determining a time index corresponding to the maximum value as the frame synchronization.

13. The method of claim 12, wherein the computation step comprises:
performing phase compensation on the input sample data in accordance with the corresponding pattern and summing the phase-compensated sample data with a specific time interval;
computing the complex magnitudes of sums obtained from the summation; and
computing a correlation value of a corresponding pattern with respect to each time index by accumulating the magnitudes in a sliding window manner.

14. The method of claim 12, wherein a correlation value for a time index n is obtained according to
$${C}_{i} ( n ) = {\sum }_{k = 0}^{{N}_{corr} - 1} {\vert {\sum }_{m = 0}^{{N}_{rep} - 1} y ( n - k - m \cdot ⌊ \frac{{N}_{fft}}{{N}_{rep}} ⌋ ) exp ( - \frac{j2π m i}{{N}_{rep}} ) \vert}^{2} ,$$
where i denotes an index of a preamble sub-carrier pattern, y( ) denotes input sample data, N_{fft} denotes a fast Fourier transform (FFT) size, and Nᵣₑₚ denotes the number of repetitions of a preamble in a time domain.

15. A method of acquiring frame synchronization in a broadband wireless communication system, the method comprising the steps of:
performing phase compensation on input sample data at a specific time according to a preamble sub-carrier pattern;
summing the phase-compensated sample data with a specific time interval in accordance with the pattern;
computing the complex magnitudes of sums obtained from the summation; and
computing correlation values for respective time indices by accumulating the magnitudes obtained from the computation in a sliding window manner.

16. The method of claim 15, further comprising comparing the computed correlation values so as to select a maximum correlation value and determining a time index corresponding to the maximum value as the frame synchronization.

17. The method of claim 15, wherein a correlation value for a time index n is obtained according to
$${C}_{i} ( n ) = {\sum }_{k = 0}^{{N}_{corr} - 1} {\vert {\sum }_{m = 0}^{{N}_{rep} - 1} y ( n - k - m \cdot ⌊ \frac{{N}_{fft}}{{N}_{rep}} ⌋ ) exp ( - \frac{j2π m i}{{N}_{rep}} ) \vert}^{2} ,$$
where i denotes an index of a preamble sub-carrier pattern, y( ) denotes input sample data, N_{fft} denotes a fast Fourier transform (FFT) size, and Nᵣₑₚ denotes the number of repetitions of a preamble in a time domain.

18. A method of acquiring frame synchronization in a multiple-antenna communication system using a plurality of preamble sub-carrier patterns, the method comprising the steps of:
computing, in association with a plurality of reception antennas, correlation values for respective time indices by using input sample data after performing phase compensation on the input sample data with respect to each of the preamble sub-carrier patterns;
summing the computed correlation values with respect to each time index; and
comparing sums obtained from the summation so as to select a maximum value and determining a time index corresponding to the maximum value as the frame synchronization.

19. The method of claim 18, wherein the computation step comprises:
performing phase compensation on the input sample data in accordance with the corresponding pattern and summing the phase-compensated sample data with a specific time interval;
computing the complex magnitudes of sums obtained from the summation; and
computing a correlation value of a corresponding pattern with respect to each time index by accumulating the magnitudes in a sliding window manner.

20. The method of claim 18, wherein the a correlation value for a time index n is obtained according
$${C}_{i} ( n ) = {\sum }_{k = 0}^{{N}_{corr} - 1} {\vert {\sum }_{m = 0}^{{N}_{rep} - 1} y ( n - k - m \cdot ⌊ \frac{{N}_{fft}}{{N}_{rep}} ⌋ ) exp ( - \frac{j2π m i}{{N}_{rep}} ) \vert}^{2} ,$$
where i denotes an index of a preamble sub-carrier pattern, y( ) denotes input sample data, N_{fft} denotes a fast Fourier transform (FFT) size, and Nᵣₑₚ denotes the number of repetitions of a preamble in a time domain.

21. The method of claim 18, further comprising:
summing the computed correlation values with respect to the same pattern; and
identifying a pattern having a maximum value by comparing the sums obtained from the summation.
